(19) United States
(12) Patent Application Publication
(10) Pub. No.: US 2017/0060407 A1
(43) Pub. Date: Mar. 2, 2017

(54) ELECTRONIC APPARATUS AND METHOD

(71) Applicant: Kabushiki Kaisha Toshiba, Tokyo (JP)

(72) Inventors: Yuki Kanbe, Ome Tokyo (JP); Tatsuo Yamaguchi, Kunitachi Tokyo (JP); Toshiyuki Yamagami, Fussa Tokyo (JP); Yukihiro Kurita, Kokubunji Tokyo (JP); Shogo Ikeda, Kunitachi Tokyo (JP)

(21) Appl. No.: 15/013,799

(22) Filed: Feb. 2, 2016

Related U.S. Application Data
(60) Provisional application No. 62/210,603, filed on Aug. 27, 2015.

(51) Int. Cl. G06F 3/0488; G06F 3/0484

(52) U.S. Cl. CPC G06F 3/04883; G06F 3/04842

(57) ABSTRACT

According to one embodiment, an electronic apparatus includes a display and a hardware processor. The hardware processor is configured to receive a first area of the display according to an ser operation to select at least one object at a first timing, identify a first selection candidate comprising a first object within the first area at the first timing, identify a second selection candidate comprising a second object within the first area at a second timing, wherein the second timing is a first period before the first timing, display the first selection candidate and the second selection candidate on the display, select the first object if the first selection candidate is selected, and select the second object if the second selection candidate is selected.

### CROSS-REFERENCE TO RELATED APPLICATIONS

This application claims the benefit of U.S. Provisional Application No. 62/210,603, filed Aug. 27, 2015, the entire contents of which are incorporated herein by reference.

### FIELD

Embodiments described herein relate generally to an electronic apparatus and a method.

### BACKGROUND

Various electronic apparatuses, such as a tablet computer, a smartphone, and a personal digital assistant (PDA), have spread widely in recent years. Most of the electronic apparatuses of this kind may have a touchscreen display.

A touchscreen display detects contact (position) of a stylus or a finger of a user to the screen of an electronic apparatus. Therefore, an electronic apparatus which has a touchscreen display can display on the screen (strokes forming) a character, a table, etc., for example, which a user writes down in handwriting on the screen.

Here, an electronic apparatus frequently executes the copy (and paste) of objects, such as text, a graphic, and an image currently displayed on the screen, in order to reduce a user's input operation. It should be noted that any stroke input through writing by hand will also be included in the object which is the target of a copy (hereinafter referred to as a target object).

When copying a target object, it is necessary to select the target object from two or more objects currently displayed on the screen. However, if a target object is a stroke group and the target object is intricately combined with (overlaps with) the other strokes, it is difficult to appropriately select (a stroke group of) the target object from two or more strokes currently displayed on the screen.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view illustrating an exemplary appearance of an electronic apparatus in an embodiment.

FIG. 2 is a view illustrating an example of connection between apparatuses each using a handwriting collaboration function.

FIG. 3 is a view illustrating an example of a flow of data between a server apparatus and each of the other apparatuses.

FIG. 4 is a view for explaining an example of a shared screen image.

FIG. 5 is a view for explaining an example of stroke data.

FIG. 6 is an illustrative view for explaining the gist of handwritten document data including stroke data.

FIG. 7 is a view illustrating an example of a system configuration of the electronic apparatus.

FIG. 8 is a view illustrating an example of a functional configuration of the electronic apparatus 10.

FIG. 9 is a view illustrating an example of a data structure of a stroke database.

FIG. 10 is a view illustrating an example of a data structure of the stroke database in the case of being managed in the unit of point data.

FIG. 11 is a flowchart which illustrates an example of a process procedure of the electronic apparatus at the time of using a copy assistance function.

FIG. 12 is a view for explaining an example of an operation of the electronic apparatus.

FIG. 13 is a view for explaining an example of an operation of the electronic apparatus.

FIG. 14 is a view for explaining an example of an operation of the electronic apparatus.

FIG. 15 is a view for explaining an example of an operation of the electronic apparatus.

FIG. 16 is a view for explaining an example of an operation of the electronic apparatus.

### DETAILED DESCRIPTION

Various embodiments will be described hereinafter with reference to the accompanying drawings.

In general, according to one embodiment, an electronic apparatus includes a display and a hardware processor. The display displays a document including objects on the display. The hardware processor is configured to receive a first area of the display according to an ser operation to select at least one object at a first timing, identify a first selection candidate comprising a first object within the first area at the first timing, identify a second selection candidate comprising a second object within the first area at a second timing, wherein the second timing is a first period before the first timing, display the first selection candidate and the second selection candidate on the display, select the first object if the first selection candidate is selected, and select the second object if the second selection candidate is selected.

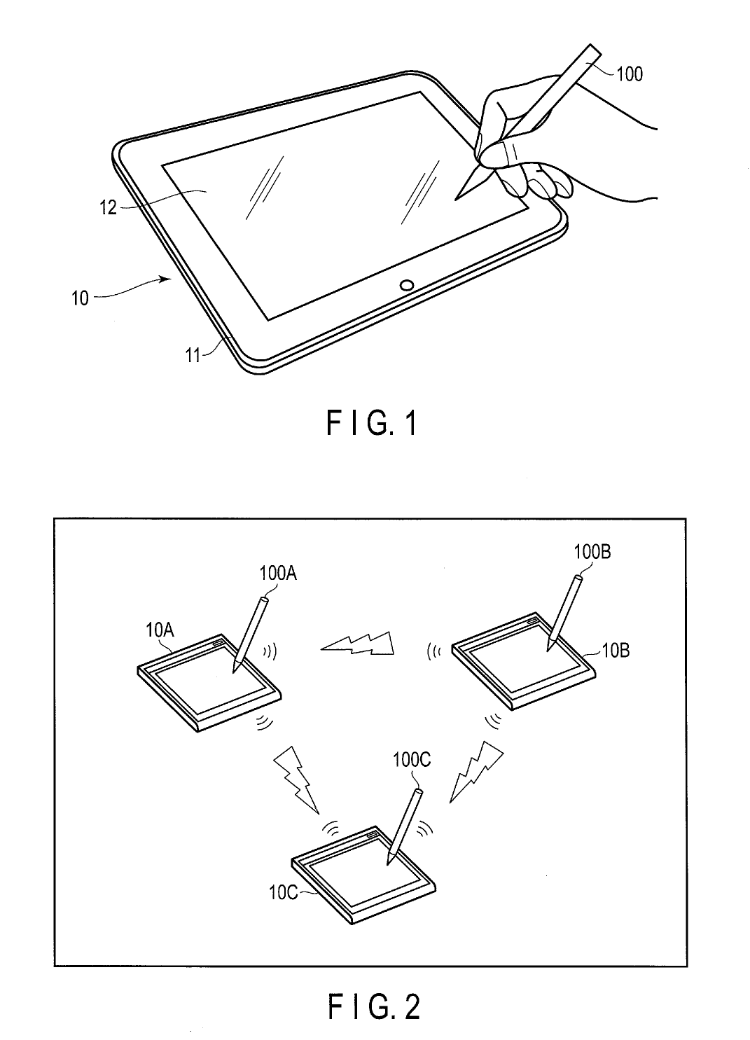

FIG. 1 is a perspective view illustrating the appearance of an electronic apparatus in one embodiment. This electronic apparatus is a stylus-based portable electronic apparatus in which an input using a stylus or a finger is possible, for example. The electronic apparatus may be implemented as a tablet computer, a smartphone, a PDA, etc. FIG. 1 illustrates an example in which the electronic apparatus is implemented as a tablet computer. A case where an electronic apparatus in the embodiment is a tablet computer will be explained below. A tablet computer is a portable electronic apparatus, and is also called as a tablet or a slate computer.

The electronic apparatus 10 illustrated in FIG. 1 includes a main body 11 and a touchscreen display 12. The main body 11 includes a housing in the shape of a thin box. The touchscreen display 12 is attached in such a manner that it may be overlaid on the top face of the main body 11.

A flat panel display and a sensor are built into the touchscreen display 12. The flat panel display includes a liquid crystal display (LCD), for example. The sensor is configured to detect a touch position of a stylus or a finger on a screen of the flat panel display. A capacitive touchpanel, an electromagnetic induction digitizer, etc., may be used as a sensor, for example. In the following explanation, it is assumed that two kinds of sensors, a touchpanel and a digitizer, are both built into the touchscreen display 12.

The touchscreen display 12 can detect not only an operation of touching the screen by finger but also an operation of touching the screen by a stylus 100. The stylus 100 includes an electromagnetic-induction stylus (digitizer stylus), for example. The user can perform a handwriting input operation on the touchscreen display 12 using the stylus 100. The handwriting input operation allows the user to form a character, a table, a graphic, etc., by handwriting on the screen of the electronic apparatus 10. In the handwriting input operation, trails (handwritten marks) left by moving the stylus 100 on the screen, i.e., the trails of strokes made by hand while executing a handwriting input operation will be successively presented in real time, and the trail of each stroke will be displayed on the screen. A trail left by a motion of the stylus 100 while the stylus 100 is in contact with the screen is equivalent to one stroke. A set of many strokes corresponding to a character, a symbol, or a table written or drawn in longhand, i.e., a set of many trails (handwritten marks) constitutes a handwritten document.

In the present embodiment, a handwritten document is saved on a storage medium, not as image data, but as data indicating a coordinate string of a trail of each stroke and the order of strokes (hereinafter, referred to as handwritten document data). Although the details of handwritten document data will be described later, the handwritten document data indicates order in which two or more strokes have been written by hand (namely, writing order), and includes stroke data items corresponding to the strokes, respectively. In other words, handwritten document data means a set of time-series stroke data items corresponding to the strokes, respectively. Each stroke data item indicates one certain stroke, and includes (a set of) point data items indicative of those points that constitute a trail of the stroke. Each point data item indicates the coordinates of a corresponding one of the points.

Furthermore, the electronic apparatus 10 has a handwriting collaboration function. The handwriting collaboration function provides, for example, a service which allows two or more apparatuses including the electronic apparatus 10 to share the shared information which includes stroke data. The handwriting collaboration function enables the users who use their respective apparatuses to peruse the shared information, to exchange the shared information among the apparatuses, and to edit the shared information according to cooperative work with the users of other apparatuses. It should be noted that the shared information sharable in the handwriting collaboration function includes handwritten document data (stroke data), text data, presentation data, word processing data, image data, spreadsheet data, their combination, etc., for example.

The handwriting collaboration function is used by a group including two or more users (a group in which two or more users have participated). The group includes an owner of the group and participants in the group. It should be noted that any group includes one owner and at least one participant.

In the handwriting collaboration function, the information which may include stroke data etc. and is input in an apparatus used by a user who has participated (logged) in a group will be distributed in real time to any apparatuses that are used by other users who have participated in the group. This makes it possible to synchronize the shared information (edited contents) displayed on the screen of each of the apparatuses used by the respective users who have participated in the group. If the strokes or the like having been hand-written or hand-drawn by different users are shared, they may be differently displayed from each other (in color, kinds of used styluses, etc., for example) so that the users who wrote or drew the strokes can be distinguished.

FIG. 2 illustrates an example of connection between apparatuses (electronic apparatuses), each using a handwriting collaboration function.

An apparatus 10A is an electronic apparatus 10 used by a user A, for example. An apparatus 103 is another electronic apparatus 10 used by a user B, for example. An apparatus 10C is a still further electronic apparatus 10 used by a user C. That is, each of apparatuses 10A to 10C has a handwriting collaboration function equivalent to the electronic apparatus 10 in the present embodiment.

Users A to C, each using a handwriting collaboration function, constitute one group. In this case, apparatuses 10A to 100 are wirelessly connected to each other, for example. Any wireless connection standard which can wirelessly connect two or more apparatuses to each other may be used as this wireless connection. Specifically, Wi-Fi (registered trademark), Wi-Fi Direct (registered trademark), Bluetooth (registered trademark), etc., may be used, for example.

Any one of the above-mentioned apparatuses 10A to 100 shall operate as a server apparatus configured to manage (groups formed by) a handwriting collaboration function. Specifically, the electronic apparatus 10 used by a user who is an owner of a group shall operate as a server apparatus.

The server apparatus (or the user who uses the server apparatus) may have the authority to permit any apparatus (or any user) to participate in the group, for example. In this case, only such an apparatus that receives from the server apparatus permission of the participation in the group can participate in the group.

If each apparatus participates in the group, an ID (account) of the apparatus itself may be used or, alternatively, an ID (account) of the user who uses the apparatus may be used.

Here, let us assume that users A to C constitute a single group. In this case, a shared screen image (page) which allows any user to peruse shared information may be displayed in each of apparatuses 10A to 10C. The shared screen image is used as a display area (edit area) common to apparatuses 10A to 10C. The shared screen image achieves visual communication among apparatuses 10A to 10C. The visual communication makes it possible to share and exchange information, including text, an image, a handwritten character, a hand-drawn graphic, a diagram, etc., in real time among the apparatuses.

Namely, the information which each of users A to C inputs into the screen of his or her own apparatus is not only displayed on the shared screen image of the apparatus which the user in question uses, but also is reflected in real time in the shared screen image of each of the apparatuses which the other users use. Accordingly, any information which users A to C input will be exchanged and shared among users A to C.

It should be noted that the size of a shared screen image can be established arbitrarily. The size of a shared screen image can also be established exceeding the size (resolution) of the physical screen of each apparatus.

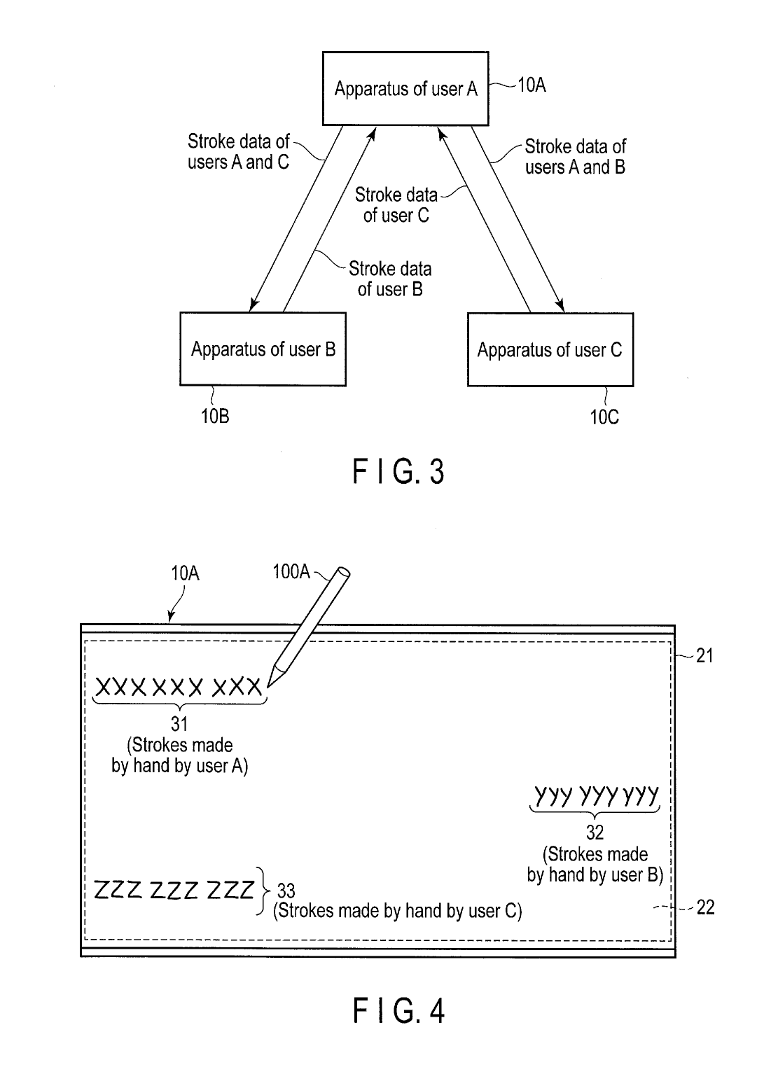

FIG. 3 illustrates a flow of data between a server apparatus and each of the other apparatuses. In FIG. 3, it is assumed that apparatus 10A used by user A operates as a server apparatus.

Although the present invention is not at all restricted to a particular embodiment, FIG. 3 illustrates a case where stroke data (handwritten document data) is exchanged and shared among three apparatuses, and the following description will be presented to explain the flow of data between apparatus (server apparatus) 10A and each of the other apparatuses 10B and 10C.

Apparatus 10A, which is a server apparatus, receives from apparatus 10B stroke data corresponding to strokes handwritten in apparatus 10B (stroke data input in handwriting in apparatus 10B). Moreover, apparatus 10A also receives from apparatus 10C stroke data corresponding to strokes handwritten in apparatus 10C (stroke data input in handwriting in apparatus 10C).

Furthermore, apparatus 10A transmits to apparatus 10B stroke data corresponding to strokes handwritten in apparatus 10A (stroke data input in handwriting in apparatus 10A), and the stroke data received from apparatus 10C. Moreover, apparatus 10A transmits to apparatus 10C the stroke data input in handwritten in apparatus 10A and the stroke data received from apparatus 10B.

Therefore, the display (shared screen image) of apparatus 10A displays not only the stroke data of user A but also both the stroke data of user B and the stroke data of user C.

Similarly, the display (shared screen image) of apparatus 103 displays not only the stroke data of user B but also both the stroke data of user A and the stroke data of user C.

Moreover, the display (shared screen image) of apparatus 10C displays not only the stroke data of user C but also both the stroke data of user A and the stroke data of user B.

Apparatus 10A stores in a database, which apparatus 10A has, the stroke data having been input into each apparatus by means of handwriting. The database is used in order to manage the shared information including the handwritten document data (stroke data), etc., having been created and edited by the group work.

FIG. 4 illustrates an example of a shared screen image displayed on, for example, apparatus 10A. Apparatus 10A displays a shared screen image 21, which includes a display region where a transparent layer 22 allowing handwritten input (a layer for handwriting) will be set. The layer 22 displays (stroke data corresponding to) strokes made by hand by the users.

In the example illustrated in FIG. 4, apparatus 10A displays the shared screen image 21 where strokes 31 made by hand by user A using the stylus 100A on the shared screen image 21 are displayed. Furthermore, other strokes handwritten in the other apparatuses are also displayed on the shared screen image 21. The other strokes handwritten in the other apparatuses may include, for example, strokes 32 made by hand by user B in apparatus 10B and strokes 33 made by hand by user C in apparatus 10C.

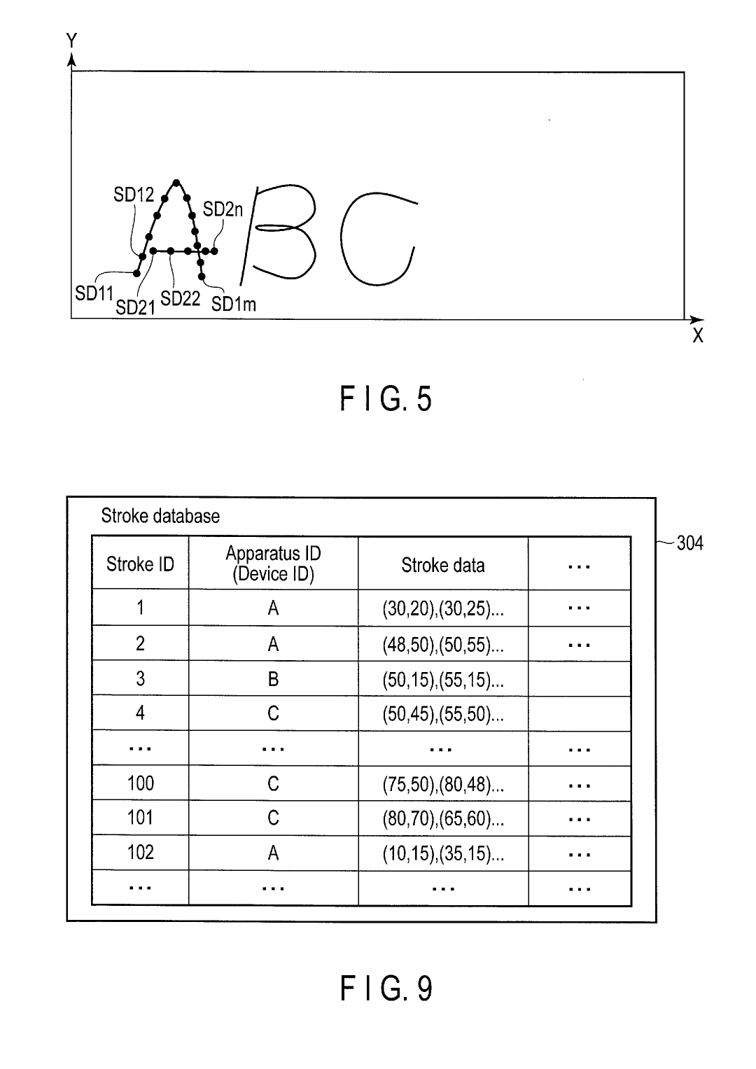

Now, stroke data will be explained below with reference to FIG. 5. In FIG. 5, it is assumed that (two or more strokes forming) a character string “ABC” is handwritten in order of “A”, “B”, and “C”.

The handwritten character “A” may be expressed by two strokes (a “̂”-shaped trail, and a “−”-shaped trail) handwritten using, for example, the stylus 100.

While the stylus 100 is moving, the “̂”-shaped trail left by the stylus 100 is subjected to sampling in real time. Thereby two or more point data items (two or more coordinate data items) SD11, SD12, . . . , SD1m that correspond to two or more points which are constituents of the “̂”-shaped trail left by the stylus 100 will be obtained one after another. That is, if the “̂”-shaped stroke is handwritten using the stylus 100, stroke data including point data items SD11, SD12, . . . , SD1m will be acquired. It should be noted that a point data item which indicates a new position may be obtained whenever the position of the stylus 100 on the screen moves for a predetermined distance, for example. Point data items are indicated in FIG. 5 at a low density for simplification of the view, but in reality two or more point data items will be obtained at much higher density. Point data items SD11, SD12, . . . SD1m included in the stroke data may be used to draw on the screen the “̂”-shaped trail left by the stylus 100. In accordance with the motion of the stylus 100, the “̂”-shaped trail left by the stylus 100 will be drawn in real time on the screen.

Similarly, the “−”-shaped trail left by the stylus 100 is also subjected to sampling in real time while the stylus 100 is moving. Thereby two or more point data items (two or more coordinate data items) SD21, SD22, . . . , SD2n that correspond to two or more points which are constituents of the “−”-shaped trail left by the stylus 100 will be obtained one after another. That is, if the “−”-shaped stroke is handwritten using the stylus 100, stroke data including point data items SD21, SD22, . . . , SD2n will be acquired.

The handwritten character “B” may be expressed by two strokes handwritten using, for example, the stylus 100. The handwritten character “C” may be expressed by one stroke handwritten using, for example, the stylus 100.

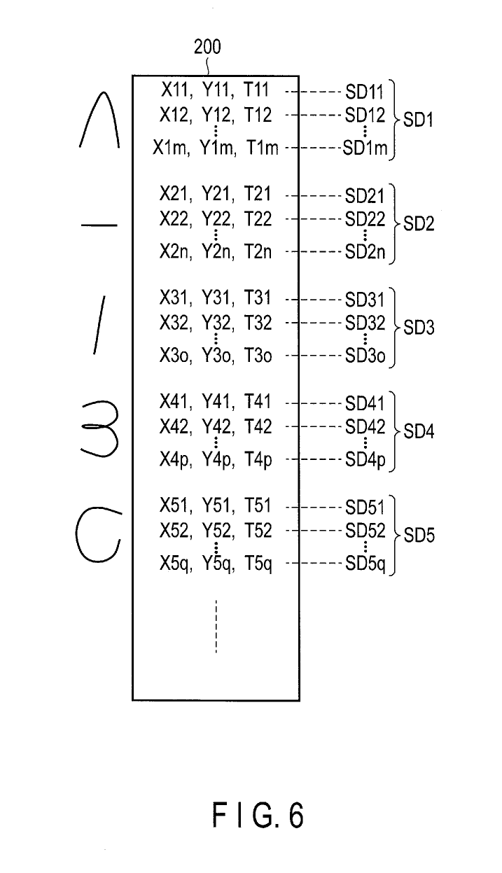

Handwritten document data 200 which includes the stroke data items illustrated in FIG. 5 will be briefly explained below with reference to FIG. 6.

The handwritten document data 200 includes two or more stroke data items SD1, SD2, . . . , SD5. The stroke data items SD1, SD2, . . . , SD5 are arranged in written order in the handwritten document data 200. That is, they are arranged in time series in the order in which two or more strokes are written by hand.

In the handwritten document data 200, two top stroke data items SD1 and SD2 indicate two strokes which form the character “A” made by hand. Third and fourth stroke data items SD3 and SD4 indicate two strokes which form the character “B” made by hand. A fifth stroke data item SD5 indicates one stroke which forms the character “C” made by hand.

Each stroke data item includes two or more point data items (coordinate data items) corresponding to one stroke. The point data items included in each stroke data item are arranged in time series in the order in which the points corresponding to the point data items are successively produced as a stroke is made by hand. Let us consider the handwritten character “A”, for example. The stroke data item SD1 includes point data items that correspond to the points which constitute a “̂”-shaped trail of a stroke in a character “A”, namely, m point data items SD11, SD12, . . . , SD1m. It should be noted that the number of point data items may be either different or the same for every stroke data.

Each point data item indicates the X- and Y-coordinates of one certain dot in a corresponding trail. For example, point data item SD11 indicates the X-coordinate (X11) and Y-coordinate (Y11) of the starting point of the “̂”-shaped stroke. SD1m indicates the X-coordinate (X1m) and Y-coordinate (Y1m) of a terminal point of the “̂”-shaped stroke.

Each point data item may include time-stamp-information T, which corresponds to the time when the point corresponding to the coordinates indicated by the point data items is handwritten (sampling timing). The time when something is handwritten may be recorded using either absolute time (for example, year, month, date, hour, minute, second) or relative time determined with reference to a certain point in time. For example, an absolute time when a stroke started being written may be added to each stroke data item as time-stamp-information, and a relative time indicating a difference from the absolute time may be further added to point data items in each stroke data item as time-stamp-information T.

The use of stroke data items (time series information) each including point data items makes it possible to accurately express the temporal relationship between strokes, since each of the point data items has time-stamp-information T as has been explained above. Although not illustrated in FIG. 6, the information (Z) indicative of the strength of a brushstroke may be added to each point data item.

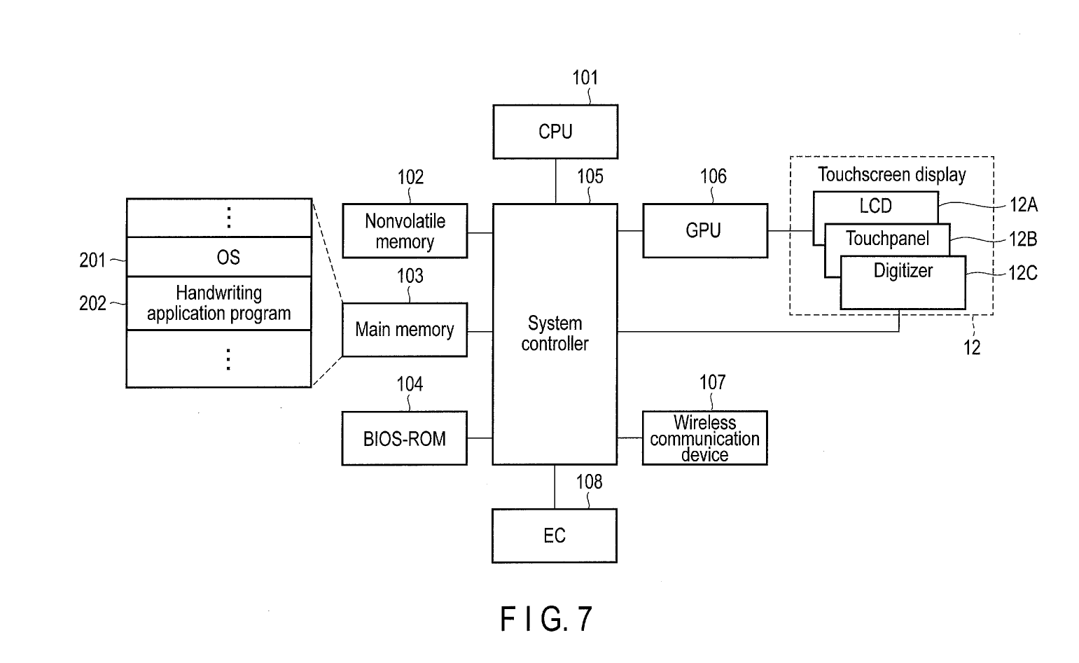

FIG. 7 illustrates the system configuration of the electronic apparatus 10. As illustrated in FIG. 7, the electronic apparatus 10 includes a CPU 101, a nonvolatile memory 102, a main memory 103, a BIOS-ROM 104, a system controller 105, a graphics processing unit (GPU) 106, a wireless communication device 107, and an embedded controller (EC) 108. The electronic apparatus 10 further includes a touchscreen display 12 such as illustrated in FIG. 1. The touchscreen display 12 includes an LCD 12A, a touchpanel 12B, and a digitizer 12C.

The CPU 101 is a hardware processor which controls operation of various components in the electronic apparatus 10. The processor includes a processing circuit. The CPU 101 executes various programs loaded to the main memory 103 from the nonvolatile memory 102 which is a storage device. An operating system 201 and various application programs are included in the programs. A handwriting application program 202 is included in the application programs.

The handwriting application program 202 has a function of creating and displaying handwritten document data, a function of editing handwritten document data, and a function of searching handwritten document data including a desired handwritten section or searching a desired handwritten section in handwritten document data.

Moreover, the handwriting application program 202 has a handwriting collaboration function for sharing shared information including stroke data among two or more apparatuses (namely, synchronizing the contents of shared information among two or more apparatuses).

Here, in a case where a user uses the electronic apparatus, a copy (and paste) of a stroke group (including an object) forming a character, a graphic, a table, etc., displayed on the shared screen image may be made. However, if two or more strokes that are made by hand by two or more users are displayed in a state where they are intricately combined or overlapped, it is difficult to select (specify) from two or more stroke groups a stroke group which is the target of a copy (and paste). Therefore, the handwriting application program 202 has, for example, a function for assisting selection of the stroke which is the target of a copy (hereinafter referred to as a selection assistance function).

In addition, the CPU 101 also executes a basic input/output system (BIOS) stored in the BIOS-ROM 104. The BIOS is a program for hardware control.

The system controller 105 is a device which connects between the local bus of the CPU 101 and various components. A memory controller which carries out access control of the main memory 103 is also built in the system controller 105. Moreover, the system controller 105 also has a function to execute communication with a GPU 106 through a serial bus conforming to the PCI EXPRESS standard, etc.

The GPU 106 is a display processor which controls the LCD 12A used as a display monitor of the electronic apparatus 10. The display signal generated by the GPU 106 is sent to the LCD 12A. The LCD 12A displays a screen image based on the display signal.

The LCD 12A has the touchpanel 12B at its upper-surface side. The touchpanel 12B is a capacitive pointing device which allows execution of input using the screen of the LCD 12A. The touchpanel 12B detects a contact position where a finger contacts the screen and a motion of the contact position.

The LCD 12A has the digitizer 12C at its undersurface side. The digitizer 12C is an electromagnetic induction type pointing device which allows input to be executed on the screen of the LCD 12A. The digitizer 12C detects a contact position where the stylus 100 contacts the screen and a motion of the contact position.

A wireless communication device 107 is a device configured to execute wireless communications, such as Wi-Fi, Wi-Fi Direct, or Bluetooth.

An EC 108 is a single-chip microcomputer including an embedded controller for control of electric power. The EC 108 has a function of turning on or off the power source of the electronic apparatus 10 in response to the user's operation of a power button.

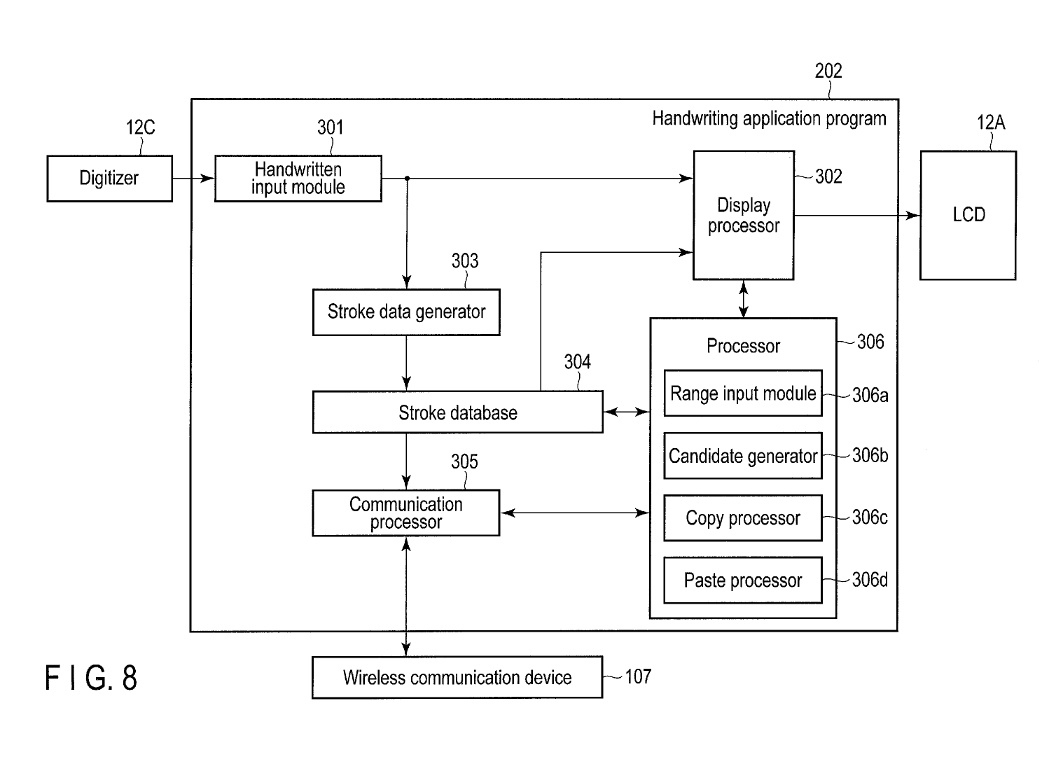

Now, the functional configuration of the electronic apparatus 10, which may be implemented by the CPU 101 (a computer of the electronic apparatus 10) executing the handwriting application program 202, will be explained with reference to FIG. 8.

The handwriting application program 202 includes as function executing modules for achieving handwritten input to the electronic apparatus 10 a handwritten input module 301, a display processor 302, a stroke data generator 303, a stroke database 304, a communication processor 305, and a processor 306. It should be noted that the stroke database 304 is stored in, for instance, the nonvolatile memory 102 which is a storage device.

The digitizer 12C which the touchscreen display 12 has is configured to detect occurrence of events, such as a touch, a move (slide), and a release. The touch is an event which indicates that the stylus 100 has touched on the screen. The move is an event which indicates that the contact position is moving while the stylus 100 is in contact with the screen. The release is an event which indicates that the stylus 100 has been separated from the screen. Such a digitizer 12C makes it possible to detect the handwritten input operation executed to the screen of the electronic apparatus 10 by using the stylus 100.

The handwritten input module 301 is an interface configured to execute a handwritten input in cooperation with the digitizer 12C. The handwritten input module 301 receives the event of a touch or a move from the digitizer 12C, and detects the handwritten input operation. The touch event includes the coordinates of the contact position. The move event includes the coordinates of the contact position of a moving destination. Consequently, the handwritten input module 301 can receive from the touchscreen display 12 (digitizer 12C) the coordinate string (two or more point data items) corresponding to the trail left by a motion of a contact position.

The display processor 302 acquires the coordinate string from the handwritten input module 301, and based on the coordinate string causes the LCD 12A to display each stroke made by hand during the handwritten input operation which uses the stylus 100. Moreover, if the user uses the handwriting collaboration function, the display processor 302 causes, under the control of the processor 306, the LCD 12A to display a shared screen image including (stroke data corresponding to) the stroke made by hand to the electronic apparatus 10 and the stroke made by hand to the other apparatus (stroke data received from the other apparatus).

The stroke data generator 303 acquires the coordinate string from the handwritten input module 301 and, based on the acquired coordinate string, generates stroke data which has such a structure that has been explained in full detail with reference to FIG. 6. The stroke data generated in this way is stored in, for example, the stroke database 304.

The communication processor 305 executes under the control of the processor 306 a process for transmitting each stroke data in the stroke database 304 to the other apparatus using the wireless communication device 107. Moreover, the communication processor 305 executes under the control of the process section 306 a process for receiving stroke data from another apparatus using the wireless communication device 107.

The processor 306 is a function executing module for implementing the handwriting collaboration function and selection assistance function.

The processor 306 executes for achieving the handwriting collaboration function a process of sharing shared information including stroke data among two or more apparatuses including the electronic apparatus 10. Specifically, the processor 306 executes a process which allows the user of the electronic apparatus 10 to create a group capable of using the handwriting collaboration function, a process which allows the user to participate in an already created group, a process which synchronizes the contents of the shared information among the apparatuses used by two or more users who constitute the group, and a process for managing the shared information.

Moreover, the processor 306 includes, for achieving the selection assistance function, a range input module 306a, a candidate generator 306b, a copy processor 306c, and a paste processor 306d.

The range input module 306a makes it possible to input (receive) a range (an area) which is specified on the touchscreen display 12 by the user's operation in the state where two or more objects including two or more strokes (handwritings) are displayed, for example, on the touchscreen display 12.

The candidate generator 306b generates (identifies) candidates (hereinafter referred to as selection target candidates) of an object which is a target of selection based on two or more objects currently displayed within the range on the touchscreen display which is input by the range input module 306a. The selection target candidates generated by the candidate generator 306b include, for example, a group of strokes that satisfy previously determined requirements and belong to the two or more strokes that are currently displayed as two or more objects within the range on the touchscreen display that is input by the range input section 306a. Furthermore, the candidate generator 306b generates two or more selection target candidates.

Two or more selection target candidates generated by the candidate generator 306b are presented (displayed) to the user through, for example, the display processor 302.

The copy processor 306c copies (stroke data corresponding to each of the) stroke groups included in the selection target candidates specified (selected) by the user among the two or more presented selection target candidates.

The paste processor 306d pastes on a specific area of the screen specified by the user the stroke group copied by the copy processor 306c.

FIG. 9 illustrates an example of a data structure of the stroke database 304 illustrated in FIG. 8. FIG. 9 illustrates an example in which (handwritten document data including) stroke data handwritten in a shared screen image displayed on two or more apparatuses is stored in a stroke database 304.

A stroke ID, an apparatus ID (a device ID), and a stroke data item (one stroke) are brought into correspondence with one another, and are stored in the stroke database 304.

The stroke ID is an identifier for identifying a corresponding stroke data item. It should be noted that the stroke ID (number) expresses the turn in which the stroke data item identified by the stroke ID is input while a handwritten input operation is executed. The apparatus ID is an identifier for identifying an apparatus to which the associated stroke data items are input while a handwritten input operation is executed. Stroke data is data corresponding to one stroke made by hand to an apparatus identified by an associated apparatus ID, and includes two or more point data items (coordinates), as mentioned above. Although FIG. 9 does not illustrate any above-mentioned time-stamp-information, let us suppose that time stamp-information-is added to stroke data (point data).

It should be noted that user IDs corresponding to stroke data items (an identifier for identifying a user who input the stroke data items while a handwritten input operation is executed) may be managed in the stroke database 304, for example.

An apparatus ID “A” is made to be associated with a stroke ID “1”, a stroke ID “2”, and a stroke ID “102”, and is stored in the stroke database 304 illustrated in FIG. 9. This indicates that the stroke data which is identified by the stroke ID “1”, the stroke ID “2”, and the stroke ID “102”, and is stored in the stroke database 304 is input into the apparatus identified by the apparatus ID “A” (for example, apparatus 10A) while a handwritten input operation is executed.

Moreover, an apparatus ID “B” is made to be associated with a stroke ID “3”, and is stored in the stroke database 304. This indicates that the stroke data which is identified by the stroke ID “3”, and is stored in the stroke database 304 is input into the apparatus identified by the apparatus ID “B” (for example, the apparatus 10B while a handwritten input operation is executed.

Furthermore, an apparatus ID “C” is made to be associated with a stroke ID “4”, a stroke ID “100”, and a stroke ID “101”, and is stored in the stroke database 304. This indicates that the stroke data which is identified by the stroke ID “4”, the stroke ID “100”, and the stroke ID “101”, and is stored in the stroke database 304 is input into the apparatus identified by the apparatus ID “C” (for example, apparatus 100) while a handwritten input operation is executed.

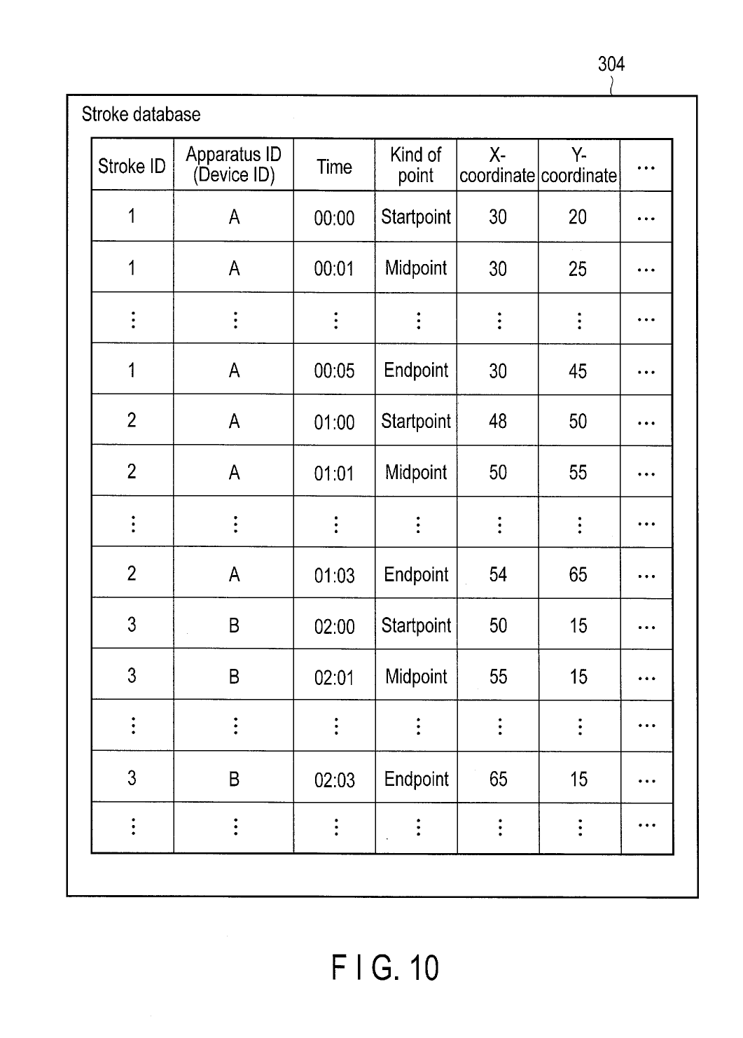

In the example illustrated in FIG. 9, data is managed in the unit of stroke (data). However, stroke data is a set of two or more point data items (coordinate data items), as mentioned above. Therefore, as illustrated, for example, in FIG. 10, it is possible to manage stroke data in the unit of point (data item) on the trail of a stroke. Therefore, if stroke data is managed in the unit of point data item, it should be assumed that transmission and reception of the stroke data at the time of use of the above-mentioned handwriting collaboration function be performed in the unit of point data item. In the case of such a configuration, it becomes possible to reproduce in more detail the state in which strokes are made.

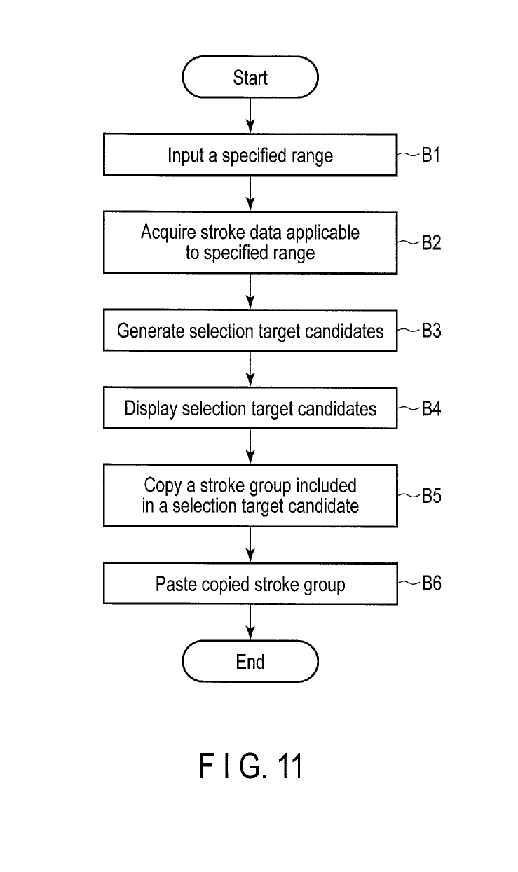

Now, the operation of the electronic apparatus 10 in the present embodiment will be explained below. Here, how the electronic apparatus 10 operate at the time of using the selection assistance function mentioned above will be mainly explained with reference to the flowchart illustrated in FIG. 11. The process illustrated in FIG. 11 is executed by the processor 306 included in the electronic apparatus 10.

On condition that two or more objects, each including strokes which a user of the electronic apparatus 10 gives by hand, are displayed on the screen of the touchscreen display 12, a selection assistance function is used if the user selects (specifies) a stroke group, the target of a copy, from the two or more objects currently displayed on the screen. In the following explanation, the stroke group which the user is going to select is called a selection target stroke group.

As described above, if a selection assistance function is used, a user performs operation of specifying a range which includes a selection target stroke group (an area displaying a selection target stroke group) in the screen of the touchscreen display 12 (hereinafter referred to as a range specification operation).

Here, a range specification operation includes operation of specifying two points on the screen of the touchscreen display 12 using, for example, the stylus 100. Specifically, the range specification operation is executed on the screen of the touchscreen display 12 using the stylus 100, and includes a first step of specifying one point and a second step of moving (sliding) the stylus 100 over the screen to specify the other point.

If such a range specification operation is performed, the range input module 306a included in the processor 306 inputs a range which is on the screen of the touchscreen display 12 and is specified by the range specification operation (hereinafter referred to as a specified range) (block B1). Let us suppose here that the specified range has a shape of a rectangle having a diagonal joining two points, which are on the screen of the touchscreen display 12 and are specified by the range specification operation.

Subsequently, the candidate generator 306b included in the processor 306 acquires from the stroke database 304 the stroke data applicable to the specified range (block B2). Specifically, the candidate generator 306b acquires two or more stroke data items corresponding to each of two or more strokes currently displayed in the specified range.

The candidate generator 306b generates selection target candidates based on two or more acquired stroke data items (block B3). The candidate generator 306b extracts from two or more acquired stroke data items a stroke data group satisfying the previously determined requirements, for example, and generates selection target candidates, each including the stroke group corresponding to the extracted stroke data group. Furthermore, two or more requirements for extracting a stroke data group shall be prepared so that selection target candidates corresponding to a selection target stroke group may be generated. Thereby, the candidate generator 306b can generate two or more selection target candidates.

The requirements for extracting a stroke data group include, for example, the time when the stroke is made by hand, the user who gives the stroke by hand, and the shape of the stroke. A specific example of (a stroke group corresponding to) the stroke data group extracted by such requirements will be described later.

As described above, if two or more selection target candidates are generated in block B3, the display processor 302 causes the touchscreen display 12 to display on the screen two or more selection target candidates (block B4).

In this case, a user selects the selection target candidate corresponding to a selection target stroke group from two or more selection target candidates displayed on the screen of the touchscreen display 12, for example.

If a selection target candidate is selected by the user, the copy processor 306c included in the processor 306 copies (the stroke data group corresponding to) the stroke group included in a selection target candidate (block B5).

If the process of block B5 is executed, the paste processor 306d included in the processor 306 will paste the copied stroke group on the screen (area) specified by the user (block B6). In this way, if a stroke group is pasted on the screen specified by the user, the stroke data group corresponding to the stroke group will be managed in the stroke database 304 in such a manner that the stroke group is made by hand to the screen.

As described above, in the process illustrated in FIG. 11, a user can execute selecting a selection target candidate corresponding to a selection target stroke group from the selection target candidates generated based on (two or more stroke data items corresponding to) two or more strokes currently displayed on the specified range in the screen of the touchscreen display 12, and copying and pasting the stroke group included in the selection target candidate.

Although the present embodiment has been explained as selection target candidates will be presented at the time of copying, it is possible that selection target candidates will be displayed at the time of pasting. Specifically, all the stroke data items acquired in block B2 are copied and the processes of block B3 and B4 are performed if the paste of (two or more strokes corresponding to) the copied stroke data items is instructed by the user. Thereby, two or more selection target candidates will be presented at the time of pasting. Therefore, it is possible for the user to paste a stroke group only by selecting the stroke group which is the target of paste, from two or more selection target candidates thus presented.

Now, an exemplary operation of the electronic apparatus 10 at the time of using the selection assistance function of the present embodiment will be explained below.

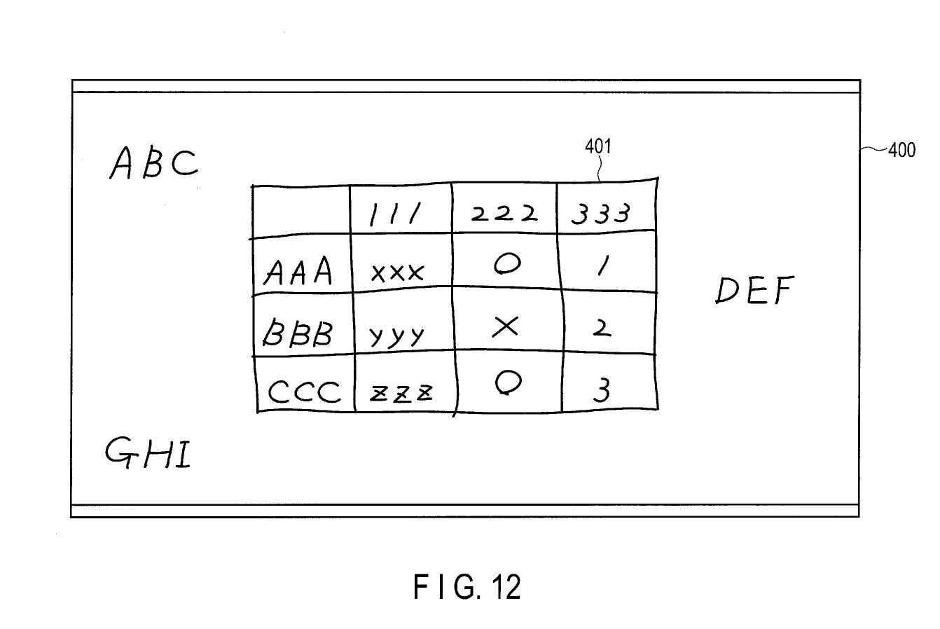

Let us suppose here that a shared screen image 400 illustrated in FIG. 12 is displayed on the touchscreen display 12 which the electronic apparatus 10 has. In the shared screen image 400, a table 401 is drawn by hand, and character strings “ABC”, “DEF”, and “GHI” are written by hand, for example. Two or more strokes which form the table 401 and the character strings “ABC”, “DEF”, and “GHI” in the shared screen image 400 include strokes which are made by hand to the electronic apparatus 10 by the user of the electronic apparatus 10 and strokes which are made by hand to other apparatuses by other users who constitute the same group as the user of the electronic apparatus 10.

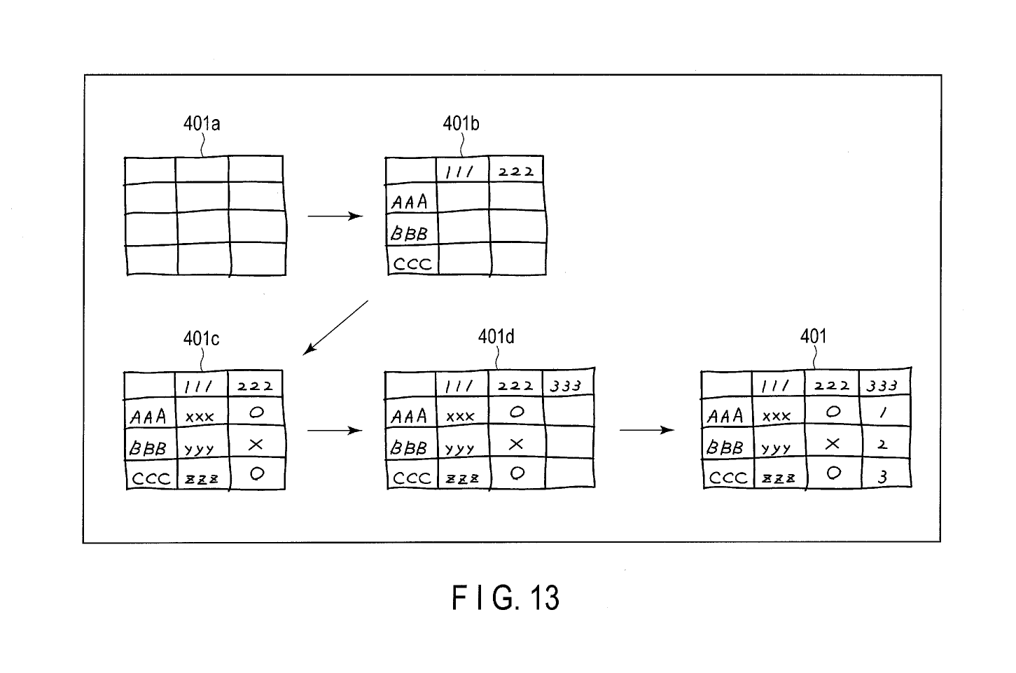

Now, the order in which the strokes forming the table 401 currently displayed on the shared screen image 400 illustrated in FIG. 12 are made by hand will be specifically explained below with reference to FIG. 13.

First of all, let us suppose that the user of the electronic apparatus 10 draws by hand using the stylus 100 the ruled lines (two or more vertical strokes and two or more horizontal strokes) 401a of the table illustrated in FIG. 13 in order to create the table 401.

Let us furthermore suppose that the user of the electronic apparatus 10 sequentially fills by hand character strings “AAA”, “BBB”, “CCC”, “111”, and “222” into two or more areas defined by the ruled lines 401a. Therefore, the shared screen image 400 of the electronic apparatus 10 will be in a state where the table 401b is exhibited, for example. Furthermore, the table 401b will be also displayed on the shared screen image of each of the other apparatuses used by the other users.

Let us further suppose that the other users of the other apparatuses sequentially describe by hand character strings “xxx”, “yyy”, “zzz”, and symbols “∘”, “x”, “∘” in the table 401b currently displayed on the shared screen images of the other apparatuses. Therefore, the shared screen image 400 of the electronic apparatus 10 and the shared screen images of the other apparatuses will be in a state where the table 401c, for instance, is displayed.

Let us furthermore suppose that the user of the electronic apparatus 10 modifies the table 401c. Specifically, let us suppose that strokes which add a column (a vertical and a horizontal ruled line) and a character string “333” are inserted by hand in the table 401c. Consequently, the shared screen image 400 of the electronic apparatus 10 and the shared screen images of the other apparatuses will be in a state where a table 401d, for instance, is displayed.

Finally, let us suppose that one of the other users using their respective apparatuses sequentially fills by hand characters “1”, “2”, and “3” into the table 401d currently displayed on the shared screen image of his or her apparatus. In this case, the shared screen image 400 of the electronic apparatus 10 and the shared screen images of the other apparatuses will be in a state where a table 401 is displayed.

In the following explanation it is supposed that the table 401 currently displayed on the shared screen image 400 of the electronic apparatus 10 has been created by hand in the above described order.

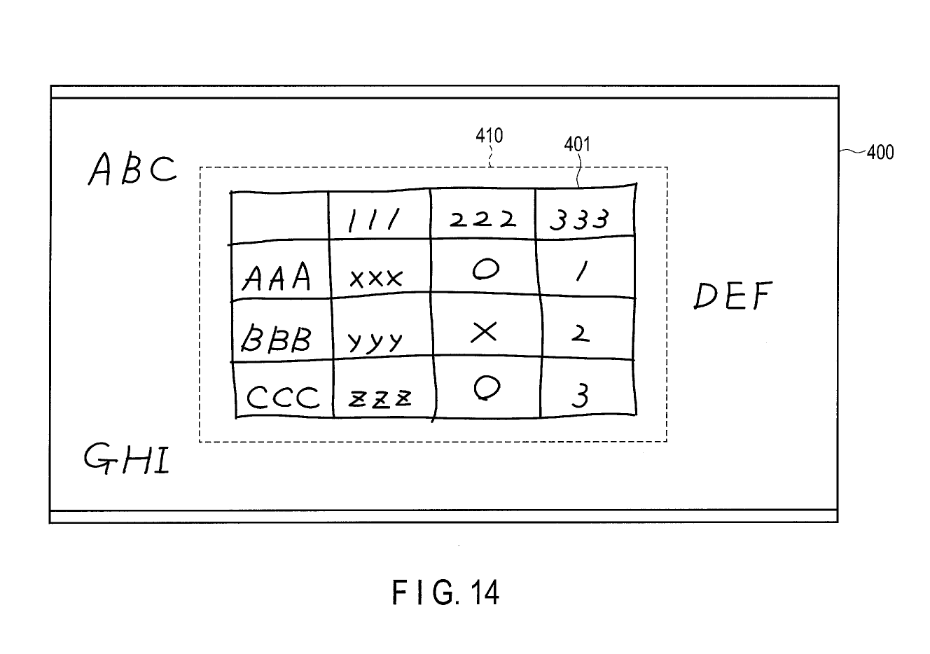

Here, if a selection assistance function is used as described above, the user who uses the electronic apparatus 10 performs a range specification operation to the touchscreen display 12 (shared screen image 400) to specify a range which includes a selection target stroke group. Here, let us assume that the stroke group corresponding to the ruled lines of the table 401 illustrated in, for example, FIG. 12 is a selection target stroke group. In this case, the user performs the range specification operation to specify a range 410 which (includes a table 401 and) is in the shared screen image 400 illustrated in FIG. 14.

Thereby, the range input module 306a inputs the range 410 specified by the range specification operation.

Subsequently, the candidate generator 306b acquires from the stroke database 304 the stroke data applicable to the input range 410. Two or more stroke data items corresponding to each of two or more strokes (for example, two or more strokes indicating the ruled line, character, and symbol of the table 401) which specifically constitute the table 401 currently displayed in the range 410 is acquired. Hereafter, two or more stroke data items acquired by the candidate generator 306b will be called an inside specific range stroke data group.

The candidate generator 306b generates a selection target candidate based on an inside specific range stroke data group. A selection target candidate is generated by using two or more previously determined requirements (hereinafter referred to as candidate extraction requirements) and extracting from the inside specific range stroke data group a stroke data group which satisfies the candidate extraction requirements (hereinafter referred to as a candidate stroke data group).

Now, the selection target candidate generated by the candidate generator 306b will be specifically explained below. It should be noted here that the first to sixth requirements will be used for the above-mentioned candidate extraction requirements as will be specifically explained below. In the following explanation, the user who uses the electronic apparatus 10 is simply called a user, and the users who use the other apparatuses are called the other users.

The first requirement includes making at least one stroke (object) which has been made at a first timing of receiving the range into a candidate. Specifically, the first requirement includes making all the inside specific range stroke data groups into a candidate stroke data group, for example. According to the first requirement, the candidate generator 306b extracts all the inside specific range stroke data groups as a candidate stroke data group, and generates a selection target candidate including (a stroke group corresponding to) the candidate stroke data group (hereinafter referred to as a first selection target candidate).

The second and third requirements include making at least one stroke (object) which has been made at a second timing in to a candidate. The second timing is a first period before the first timing.

Specifically, the second requirement includes making into a candidate stroke data group the stroke data group having been input through writing by hand two minutes or more ago, for example. According to the second requirement, the candidate generator 306b extracts the stroke data group having been input through writing by hand two minutes or more ago as a candidate stroke data group from the inside specific range stroke data groups, and generates a selection target candidate including (a stroke group corresponding to) the candidate stroke data group (hereinafter referred to as a second selection target candidate). It should be noted that the stroke data group having been input through writing by hand two minutes or more ago can be specified based on the time-stamp-information added to the stroke data.

Furthermore, the third requirement includes making into a candidate stroke data group the stroke data group having been input through writing by hand five minutes or more ago, for example. According to the third requirement, the candidate generator 306b extracts the stroke data group having been input through writing by hand five minutes or more ago as a candidate stroke data group from the inside specific range stroke data groups, and generates a selection target candidate including (a stroke group corresponding to) the candidate stroke data group (hereinafter referred to as a third selection target candidate). It should be noted that the stroke data group corresponding to the stroke group having been input through writing by hand five minutes or more ago can be specified based on the time-stamp-information added to the stroke data as has been described above.

The above-mentioned second and third requirements are requirements concerning the time when the strokes are made by hand as mentioned above.

The fourth requirement includes making into a candidate stroke data group the stroke data group which the user has input through giving strokes by hand, for example. According to the fourth requirement, the candidate generator 306b extracts the stroke data group which the user has input through giving strokes by hand (namely, a stroke data group which does not include any stroke data which the other users have input through giving strokes by hand) as a candidate stroke data group from the inside specific range stroke data groups, and generates a selection target candidate including (a stroke group corresponding to) the candidate stroke data group (hereinafter referred to as a fourth selection target candidate). It should be noted that the stroke data group which the user has input through giving strokes by hand can be specified based on the apparatus ID (or the user ID) which is associated with the stroke data and is stored in the stroke database 304.

It should be noted that the fourth requirement is a requirement concerning a user who gives a stroke by hand.

The fifth requirement includes making into a candidate stroke data group the stroke data group corresponding to the stroke group which forms a character and a symbol, for example. According to the fifth requirement, the candidate generator 306b extracts the stroke data group corresponding to the stroke group which forms a character and a symbol as a candidate stroke data group from the inside specific range stroke data groups, and generates a selection target candidate including (a stroke group corresponding to) the candidate stroke data group (hereinafter referred to as a fifth selection target candidate). It should be noted that the stroke group which forms a character and a symbol includes a stroke group (a set of strokes which form a character and a symbol) recognized as a character and a symbol by executing a character-recognition process to two or more strokes that are currently displayed, for example, in the range 410. That is, the stroke data group corresponding to the stroke group which forms a character and a symbol can be specified based on a character-recognition process result.

The sixth requirement includes making into a candidate stroke data group the stroke data group corresponding to the stroke group which forms something other than, for example, a character and a symbol. According to the sixth requirement, the candidate generator 306b extracts the stroke data group corresponding to the stroke group which does not form a character and a symbol as a candidate stroke data group from the inside specific range stroke data groups, and generates a selection target candidate including (a stroke group corresponding to) the candidate stroke data group (hereinafter referred to as a sixth selection target candidate). It should be noted that the stroke group which forms something other than a character and a symbol includes a stroke group that are not recognized as a character and a symbol by executing the character-recognition process to two or more strokes that are currently displayed, for example, in the range 410. That is, the stroke data group corresponding to the stroke group which forms something other than a character and a symbol can be specified based on a character-recognition process result.

It should be noted that the fifth and sixth requirements are requirements concerning the shape of a stroke or whether a stroke or a combination of strokes forms a character or a symbol.

The example in which the first to sixth requirements are used as candidate extraction requirements has been hitherto explained. However, the first to sixth requirements are nothing but examples. Therefore, some other requirements may be used as candidate extraction requirements. Moreover, it is possible to make such a configuration that allows a user to select some requirements from the first to sixth requirements (or to change requirements for use).

Two or more selection target candidates (the first to six copy target candidates) generated by the candidate generator 306b in this way are displayed (presented) on the candidate presentation area provided on the screen (the shared screen image 400) of the touchscreen display 12.

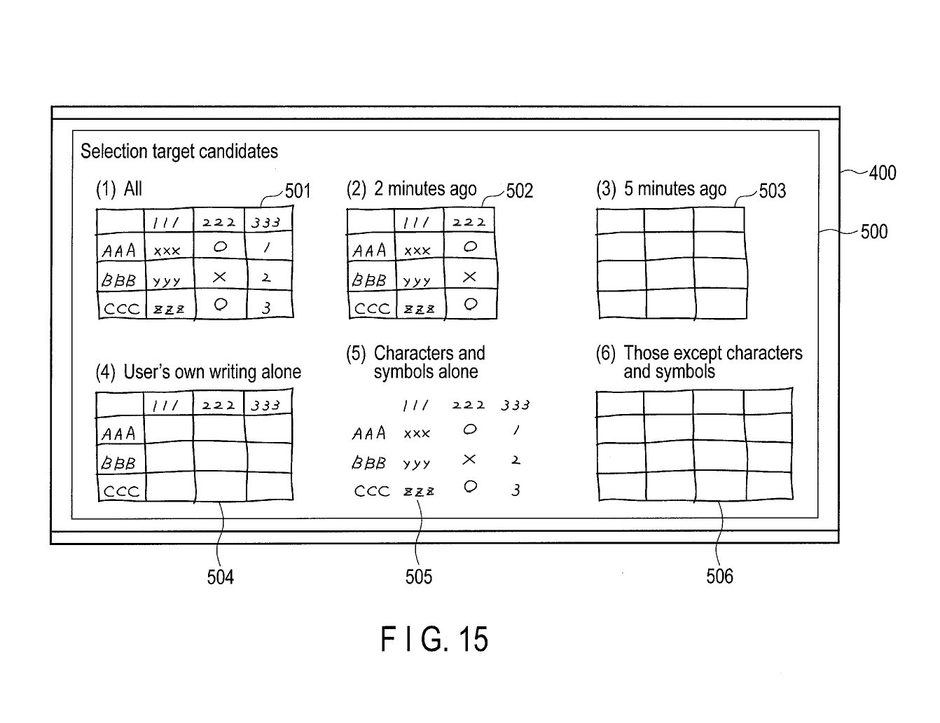

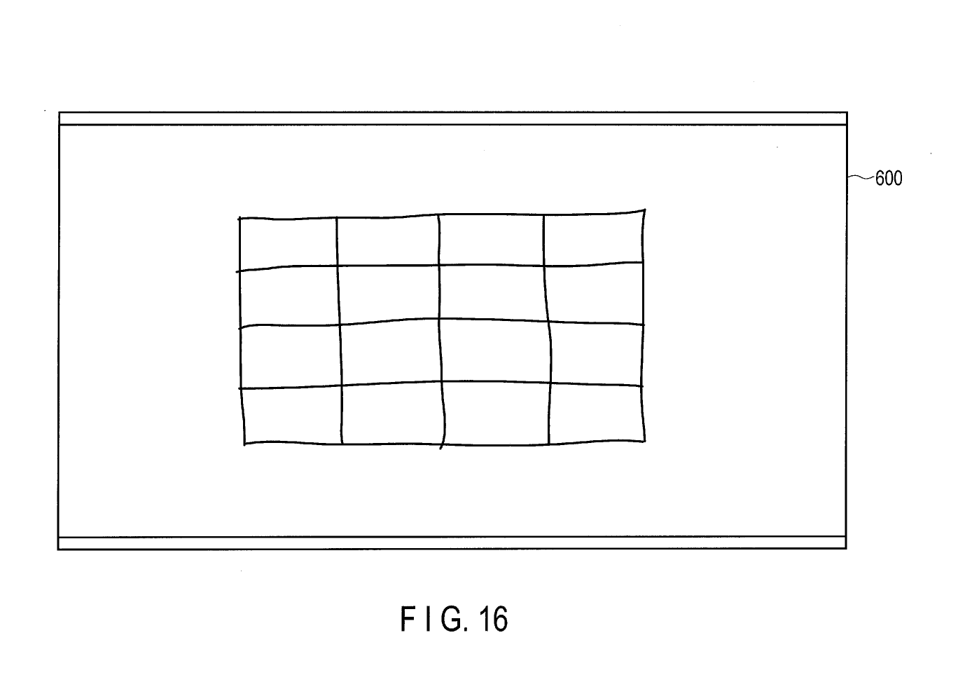

FIG. 15 illustrates an exemplary candidate presentation area 500 where the first to sixth selection target candidates are displayed.

If two or more stroke data items corresponding to the two or more strokes which form the table 401 illustrated in FIG. 12 belong to the inside specific range stroke data groups, all the strokes which form the table 401 are displayed as the first selection target candidate 501, as illustrated in FIG. 15.

Moreover, in a case where the table 401 is created by hand following the procedure having been explained with reference to FIG. 13, and where the table 401c illustrated in FIG. 13 has been created by hand two minutes ago, the stroke group which forms the table 401c will be displayed as the second selection target candidate 502.

Similarly, in a case where the ruled lines 401a of the table illustrated in FIG. 13 has been created by hand five minutes ago, the stroke group which forms the ruled lines 401a will be displayed as the third selection target candidate 503.

Moreover, only the stroke group which the user of the electronic apparatus 10 has created by hand, as has been explained with reference to FIG. 13, will be displayed as the fourth selection target candidate 504.

Furthermore, only the stroke group which forms the character and symbol which are filled by hand into the table 401 will be displayed as the fifth selection target candidate 505. It should be noted that the stroke group which forms a character and a symbol is a stroke group recognized as a character and a symbol, as a result of a character-recognition process to (two or more strokes currently displayed inside) the (specific) range 410 specified on the above-mentioned shared screen image 400.

Moreover, only the stroke group which forms something other than a character and a symbol in the table 401 will be displayed as the sixth selection target candidate 506. Here, the sixth selection target candidate 506 only includes ruled lines of the table 401, i.e., those obtained by excluding from the table 401 characters and symbols (namely, fifth selection target candidates 505). The stroke group which forms something other than a character and a symbol is a stroke group which is not recognized as a character and a symbol, as a result of a character-recognition process to (two or more strokes currently displayed inside) the (specific) range 410 specified in the above-mentioned shared screen image 400. It should be noted that there is nothing wrong with subjecting the two or more strokes currently displayed, for example, within the range 410 in the shared screen image 400 (namely, the table 401) to a table recognition process and considering as the sixth selection target candidate 506 the stroke group having been detected as the ruled lines of the table 400. The table recognition process makes it possible to detect a stroke near a straight line as a stroke applicable to a ruled line of the table 401. Similarly, it is possible to consider the stroke group which forms such a shape that is equivalent to a previously determined graphic as the sixth selection target candidate 506.

It should be noted here that, in a case where the stroke group fit for the ruled lines of the table 401 illustrated in FIG. 12 is a selection target stroke group as has been described above, the user will perform operation of selecting the sixth selection target candidate 506 currently displayed on the candidate presentation area 500. Specifically, the user brings his or her stylus 100 or finger into contact with a position on the screen of the touchscreen display 12 where the sixth selection target candidate 506 is displayed, thereby selecting the sixth selection target candidate. This allows the (stroke data group corresponding to the) stroke group included in the sixth selection target candidate 506 to be copied.

The stroke group copied in this way (the stroke group fit for the ruled lines of the table 400) can be pasted on the screen image 600 different from the shared screen image 400, as illustrated in FIG. 16.

A case where the sixth selection target candidate 506 is selected has been hitherto explained. However, even if the other selection target candidates (the first to five copy target candidates 501 to 505) are selected, the stroke group included in a selection target candidate can be copied and pasted in a similar manner.

As has been described above, in the present embodiment, two or more strokes (objects) which a user gives by hand are displayed on (the screen of) the touchscreen display 12, a range (an area) defined in the touchscreen display 12 is input (received) according to an operation of the user, a selection target candidate (for example, a candidate of the stroke group which is the target of copy or paste) is generated (identified) based on two or more strokes currently displayed within the input range, and the generated selection target candidate is presented. It should be noted that the selection target candidate includes a first selection candidate including a object within the range at a first timing of inputting the range and a second selection candidate including a object within the range at a second timing. The second timing is a period before the first timing.

Since the present embodiment has the above-mentioned configuration, even if two or more strokes currently displayed on the screen of the touchscreen display 12 are intricately put together (overlap one another), for example, it is not necessary to perform complicated operation such as manually selecting one by one all the strokes that are included in a stroke group which is a target of copy or paste (a selection target stroke group). That is, the user can select appropriately and easily (a stroke group corresponding to) a selection target stroke group by only executing a simple operation of roughly specifying a range in which the selection target stroke group is displayed.

In the present embodiment, the stroke group that are included in a selection target candidate and are selected by the user can be copied and pasted, for example. It should be noted that the stroke group that are included in the selection target candidate and are selected by the user may be used for processes other than copy and paste. Namely, the embodiment may be applicable to a case where a specific stroke group should be selected from two or more strokes that are currently displayed on the screen of the touchscreen display 12 and are intricately put together (overlap one another).

In the present embodiment, a selection target candidate is generated based on the time when each of the strokes currently displayed within the input range is made (written or drawn time). In other words, for example, a first selection target candidate including at least one stroke (handwriting) which has been made at the first timing is generated. Moreover, a second selection target candidate including at least one stroke (handwriting) which has been made at the second timing.

Furthermore, in a case where two or more strokes currently displayed on the screen (shared screen image) of the touchscreen display 12 include strokes made by hand to the screen of the touchscreen display 12 by a user (a first user) who uses the electronic apparatus 10 and strokes made by hand to the display of another apparatus by another user (a second user) who uses another apparatus other than the electronic apparatus 10, a selection target candidate will be generated based on the users (writers) who give by hand their respective strokes currently displayed within the input range in the present embodiment.

Furthermore, a selection target candidate is generated based on the shape of each of the strokes currently displayed within input range in the present embodiment. Specifically, a third selection target candidate including at least one stroke (handwriting) which is recognized as at least one character or symbol is generated, and a fourth selection target candidate including at least one stroke (handwriting) which is not recognized as at least one character or symbol.

Since the present embodiment has such a configuration, it can present selection target candidates which are generated based on various viewpoints. Consequently, the present embodiment can present any stroke group (selection target stroke group) which a user desires as a selection target candidate.

It should be noted that a case where two or more objects displayed on the screen of the touchscreen display 12 are two or more strokes has been mainly explained as the present embodiment. However, objects other than strokes may be included in the two or more objects. For example, text, a graphic, an image, etc., may be included in the objects. Moreover, if two or more objects of a different kind are displayed in this way on the screen of the touchscreen display 12, the selection target candidate presented to a user may be generated based on each kind of two or more objects currently displayed within an input range. Specifically, it is possible to present not only a selection target candidate including the above-mentioned stroke group, but also a selection target candidate including only text, a selection target candidate including only a graphic, a selection target candidate including only an image, and a selection target candidate including a combination of them.

Although a case where a specific stroke group is selected from two or more strokes (namely, two or more strokes made by hand by two or more users) displayed on the shared screen image has been mainly explained as the present embodiment, the present embodiment may be applied when selecting a specific stroke group from two or more strokes made by hand only by the user who uses the electronic apparatus 10.

Moreover, although the electronic apparatus 10 in the present embodiment has been explained as having the touchpanel 12B and the digitizer 12C, it may be applied to the electronic apparatus (for example, a notebook type personal computer etc.) having a keyboard, a mouse, etc., instead of the touchpanel 12B and the digitizer 12C, as long as the present embodiment can perform the above-mentioned range specification operation and so forth.

It should be noted that various functions described above to explain the present embodiment may be implemented by a processing circuit (a hardware processor). A programmed processor such as a central processing unit (CPU) is included in the processing circuit. The processor may achieve each of the above-mentioned functions by executing a corresponding program stored in a memory. The processor may be a microprocessor including an electronic circuit. The processing circuit includes a digital signal processor (DSP), an application-specific integrated circuit (ASIC), a microcontroller, a controller, and other electronic components.

Moreover, since various processes of the present embodiment may be implemented by a computer program, advantages similar to the advantages of the present embodiment may be easily achieved only by installing the computer program in a usual computer through a computer-readable storage medium storing the computer program and causing the computer to execute the installed computer program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a display that displays a document comprising objects on the display; and
a hardware processor configured to:
receive a first area of the display according to an user operation to select at least one object at a first timing;
identify a first selection candidate comprising a first object within the first area at the first timing;
identify a second selection candidate comprising a second object within the first area at a second timing, wherein the second timing is a first period before the first timing;
display the first selection candidate and the second selection candidate on the display;
select the first object if the first selection candidate is selected; and
select the second object if the second selection candidate is selected.

2. The electronic apparatus of claim 1, wherein the hardware processor is configured to:
copy or paste the first object if the first object is selected, and
copy or paste the second object if the second object is selected.

3. The electronic apparatus of claim 1, wherein the objects include handwritings.

4. The electronic apparatus of claim 3, wherein
the first selection candidate comprises at least one handwriting which has been made at the first timing, and
the second selection candidate comprises at least one handwriting which has been made at the second timing.

5. The electronic apparatus of claim 4, wherein
the handwritings comprise at least one first handwriting by a first user and at least one second handwriting by a second user, and
the hardware processor is configured to:
identify a third selection candidate comprising the first handwriting,
display the third selection candidate on the display, and
select the first handwriting if the third selection candidate is selected.

6. The electronic apparatus of claim 4, wherein
The hardware processor is configured to:
identify a third selection candidate comprising at least one first handwriting which forms at least one character or symbol,
identify a fourth selection candidate comprising at least one second handwriting which does not form at least one character or symbol,
display the third selection candidate and the fourth selection candidate on the display,
select the first handwriting if the third selection candidate is selected, and
select the second handwriting if the fourth selection candidate is selected.

7. The electronic apparatus of claim 1, wherein
the objects include objects of a different kind, and
the hardware processor is configured to:
identify a third selection candidate comprising a first kind of object,
identify a fourth selection candidate comprising a second kind of object,
display the third selection candidate and the fourth selection candidate on the display,
select the first kind of object if the third selection candidate is selected, and
select the second kind of object if the fourth selection candidate is selected.

8. The electronic apparatus of claim 1, wherein
the hardware processor comprises:
means for receiving a area of the display according to an user operation to select at least one object at a first timing;
means for identifying a first selection candidate comprising a first object within the first area at the first timing;
means for identifying a second selection candidate comprising a second object within the first area at a second timing, wherein the second timing is a first period before the first timing;
means for displaying the first selection candidate and the second selection candidate on the display;
means for selecting the first object if the first selection candidate is selected; and
means for selecting the second object if the second selection candidate is selected.

9. A method, executed by an electronic apparatus comprising a display that displays a document comprising objects on the display, comprising:
receiving a first area of the display according to an user operation to select at least one object at a first timing;
identifying a first selection candidate comprising a first object within the first area at the first timing;
identifying a second selection candidate comprising a second object within the first area at a second timing, wherein the second timing is a first period before the first timing;
displaying the first selection candidate and the second selection candidate on the display;
selecting the first object if the first selection candidate is selected; and
selecting the second object if the second selection candidate is selected.

10. The method of claim 9, further comprising
copying or pasting the first object if the first object is selected, and
copying or pasting the second object if the second object is selected.

11. The method of claim 9, wherein the objects include handwritings.

12. The method of claim 11, wherein
the first selection candidate comprises at least one handwriting which has been made at the first timing, and
the second selection candidate comprises at least one handwriting which has been made at the second timing.

13. The method of claim 12, wherein the handwritings comprise at least one first handwriting by a first user and at least one second handwriting by a second user, and
further comprising:
identifying a third selection candidate comprising the first handwriting,
displaying the third selection candidate on the display, and
selecting the first handwriting if the third selection candidate is selected.

14. The method of claim 12, further comprising:
identifying a third selection candidate comprising at least one first handwriting which forms at least one character or symbol,
identifying a fourth selection candidate comprising at least one second handwriting which does not form at least one character or symbol,
displaying the third selection candidate and the fourth selection candidate on the display,
selecting the first handwriting if the third selection candidate is selected, and
selecting the second handwriting if the fourth selection candidate is selected.

15. The method of claim 9, wherein the objects include objects of a different kind, and
further comprising:
identifying a third selection candidate comprising a first kind of object,
identifying a fourth selection candidate comprising a second kind of object,
displaying the third selection candidate and the fourth selection candidate on the display,
selecting the first kind of object if the third selection candidate is selected, and
selecting the second kind of object if the fourth selection candidate is selected
